(19) United States
(12) Patent Application Publication
(10) Pub. No.: US 2017/0206525 A1
(43) Pub. Date: Jul. 20, 2017

(54) ONLINE TRANSACTION AUTHORIZATION VIA A MOBILE DEVICE APPLICATION

(71) Applicant: GENBAND US LLC, Frisco, TX (US)

(72) Inventor: Dany Sylvain, Gatineau (CA)

(73) Assignee: GENBAND US LLC, Frisco, TX (US)

(21) Appl. No.: 15/000,086

(22) Filed: Jan. 19, 2016

(51) Int. Cl. G06Q 20/40; G06Q 20/32

(52) U.S. Cl. CPC G06Q 20/405; G06Q 20/3226; G06Q 20/40145; G06Q 20/3224

(57) ABSTRACT

A method and system for providing a service node for authenticating online transactions. The authentication service node improves the ability to verify that an online transaction is made by an authenticated user. The authentication service node receives a request to authenticate a transaction, such as a purchase from an online merchant made by a purchaser using a first device and providing a user identifier such as a user name and password. The authentication service node identifies a second device associated with the provided user identifier, where the second device has been configured to validate inputs by a person associated with the provided user identifier. The service node sends the second device a request to confirm the online transaction and receives a determination specifying whether inputs providing by the user of second device match inputs provided previously by the user associated with the user identifier.

### TECHNICAL FIELD

This disclosure relates generally to improvements in online transaction authentication, in particular online transaction authentication using a mobile device.

### BACKGROUND

The following discussion sets forth the inventors' own knowledge of certain technologies and/or problems associated therewith. Accordingly, this discussion is not an admission of prior art, and it is not an admission of the knowledge available to a person of ordinary skill in the art.

Credit cards are used extensively for payment in online commerce. However, credit card information regularly falls into the hands of hackers and thieves. Online merchants are unable discern whether a purchase is being made by a legitimate cardholder. Since legitimate cardholders are usually not held responsible for purchases made when their credit card information has been stolen, merchants and banks are forced to assume these ever increasing financial losses. In some scenarios, legitimate cardholders can be left with ruinous amounts of debt.

To minimize the risk of allowing purchases by illegitimate cardholders, online merchants and payment processors have introduced improved authentication measures that require providing more than a credit card number to make a purchase. One such security measure is two-factor authentication, whereby in addition to a providing a credit card number, a purchaser must also authenticate and authorize the transaction via another device. A common two-factor authentication scheme requires a purchase to be confirmed by responding to an SMS (i.e., text′ message sent to the purchaser's mobile device with a code which must be entered by the user on the online merchant's web site.

This type of authentication can be effective but has several limitations. For instance, since online merchants do not commonly track mobile device numbers that are associated with their customers, users are required to enter a mobile number at each transaction. A second limitation is the inability of merchants to determine whether a provided mobile number is actually owned or controlled by the account holder. This presents an opportunity for malicious actors with compromised password information to circumvent any mobile device authentication system by configuring the user's account to allow transaction authentication from a mobile device controlled by the malicious actor. A third limitation of conventional systems is the inherent vulnerability of password authentication. Most online merchants require customers to create an account and provide a password to be used to authenticate the customer. Best practices requires the customer to provide a password that is hard to guess and is resilient to dictionary attacks, thus making the password difficult for the user to remember. Another best practice is to use different passwords for each online merchant, thus further compounding the challenge for the user. As a consequence, users frequently deviate from these best practices, leaving password protected accounts vulnerable to malicious actors. Even when users employ best practices, security breaches of online merchant's servers commonly results in password information being compromised.

In many conventional systems, any second authentication factor can be configured by anyone that successfully negotiates the first authentication factor. Thus a malicious actor with compromised password information can bypass the first authentication factor and configure the second authentication factor in a manner that allows the malicious actor to remain undetected longer, thereby providing more opportunity to commit fraudulent activities.

Accordingly, there is a need for multi-factor authentication of online transactions that cannot be circumvented simply by defeating an online merchant's password authentication scheme. There is an additional need to provide reliable single-factor authentication that does not rely on password verification. To address these and other needs, the inventors hereof have developed an improvement in the ability to provide multi-factor and single factor authentication using a previously configured device.

### SUMMARY

Embodiments provide the ability to improve the ability to authenticate the identity of a purchaser seeking to make an online transaction. The claimed systems and methods are used to receive authentication requests from online merchants and provide an authentication factor that utilizes a previously configured authentication application to request confirmation from the user. The user confirms the purchase by providing inputs, such as a fingerprint, that must match inputs provided previously. In this manner effective multi-factor transaction authentication services can be provided while minimizing the inconvenience to users of the authentication service. In order to compromise the system, a malicious actor must defeat a first authentication factor, such as a user name and password, and a second factor that requires physical control of a previously configured device associated with the user.

Methods and systems according to various embodiments are described, the method and system for providing an online transaction authentication service node. The authentication service node also receives an external request to authenticate an online transaction, wherein a requestor making the online transaction is identified by a user identifier, and wherein the online transaction is made at a first device. The authentication service node also identifies a second device associated with the provided user identifier, wherein the second device is configured to authenticate inputs by a user associated with the user identifier. The authentication service node also sends an authentication request to confirm the online transaction to the second device. The authentication service node also receives an authentication determination from the second device, wherein the authentication determination is made based on whether inputs provided via the second device match inputs provided by the user associated with the user identifier. The authentication service node further validates the online transaction based on the received authentication determination.

According to additional embodiments, the authentication determination is performed on the at least one authentication device using user input stored on the at least one authentication device. According to additional embodiments, the authentication determination is performed on the service node using user input stored on the at least one authentication device. According to additional embodiments, the input provided by the requesting user includes at least one of: fingerprint input, iris scan input, facial recognition input, touchscreen input, motion sensor input, and voice input. According to additional embodiments, the online transaction authentication is for a financial transaction performed via an online service. According to additional embodiments, the online transaction authentication is for gaining authenticated access to an online service. According to additional embodiments, the online transaction authentication consists of a two factor authentication, where the first factor is a user identifier and a password, and the second factor is provided by the online transaction authentication service node. According to additional embodiments, the online transaction authentication consists of a one factor authentication, where the one factor is provided by the online transaction authentication service node. According to additional embodiments, the authentication request includes transaction details associated with the online transaction authentication. According to additional embodiments, the transaction details includes at least one of: source of the external request, transaction type, transaction amount, transaction currency, merchandise description, merchandise picture, service description, contact information, address information, timestamp, validity time, and location of the transaction. According to additional embodiments, the online transaction authentication determination further consists in obtaining the current location of the online transaction authentication device. According to additional embodiments, the current location is compared against at least one authorized location for the transaction. According to additional embodiments, the current location is provided to the external requester of the online transaction authentication. According to additional embodiments, the at least one authorized locations is defined by the requesting user. According to additional embodiments, the at least one authorized locations is defined by the external requester of the online transaction authentication. According to additional embodiments, the sending by the service node of an authentication request is sent to at least two user authentication devices. According to additional embodiments, the at least one user authentication device is one of: smartphone, tablet, smartwatch, computer, gaming console, remote control, door entry system, smart TV, and cam era.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items. Reference will now be made to the accompanying drawings, wherein:

FIG. 1 is a sequence diagram illustrating a conventional process for configuring a two-factor authentication scheme using a mobile device.

FIG. 2 is a block diagram of a system for providing online transaction authentication according to some embodiments.

FIG. 3 is a sequence diagram illustrating the operation of an embodiment for configuring a two-factor authentication scheme using a mobile device.

FIG. 4 is a sequence diagram illustrating the operation of an embodiment that provides online transaction verification using two-factor authentication.

FIG. 5 is a sequence diagram illustrating the operation of an embodiment that provides online transaction verification using single-factor authentication.

FIG. 6 is a sequence diagram illustrating the operation of an embodiment that provides online transaction verification using location information.

FIG. 7 is a block diagram of a system for providing online transaction authentication according to some embodiments.

FIG. 8 is a block diagram of a system for providing online transaction authentication according to some embodiments.

### DETAILED DESCRIPTION

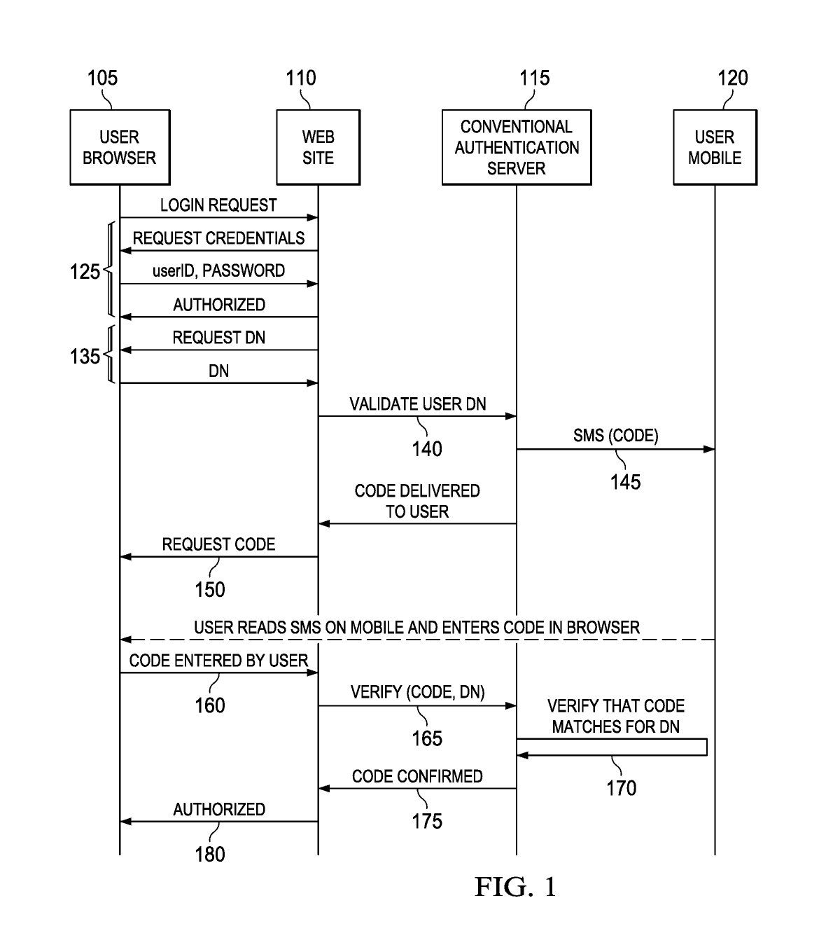

FIG. 1 illustrates a conventional process for configuring two-factor authentication that could be used for authenticating online transactions. The conventional process begins with the conventional authentication process 125 between a user operating a web browser 105 and a web site 110 provided by a web server. This conventional authentication process 125 begins with a login request by the user and request for login credentials from the web site. The user then provides a user ID and password. If the website determines that the user ID and password are legitimate, a message confirming authentication is provided to the user.

In this conventional two-factor authentication scheme, the second authentication factor requires the user to enter a confirmation code in a web browser, where the confirmation code is provided to the user via an SMS message sent to the user's mobile device. Confirmation of this second authentication factor begins with the web site 110 requesting and the user providing 135 a directory number associated with a mobile device controlled by the user. The web site 110 then proceeds to request 140 the authentication service to validate the user via the directory number. The process continues using a conventional authentication service 115 that sends the user a SMS message 145 that includes a code, frequently a series of numeric digits.

The conventional authentication service 115 continues by issuing a request for the web site to request 150 that the user provide the code in the web browser 105 from which the configuration process was initiated by the user. The user responds 160 to the request by reading the code from the SMS message sent to the user's mobile device 120 and entering that code in the browser 105. The website 110 receives the code provided by the user and forwards 165 the code and the directory number to the conventional authentication service 115. The conventional authentication service then verifies 170 that the code provided by the user via the web browser 105 matches the code provided via the user's mobile device 120. If the codes match, the conventional authentication service 115 confirms 175 the authenticity of the user to the web site 110. The web site 110 notifies 180 the user that they have been successfully authenticated. The web browser 105 then allows the online transaction to continue. Having been successfully authenticated using both factors, configuration concludes, in some conventional scenarios, with the web site 110 associating the provided directory number with the user, in order to streamline future authentication requests.

A vulnerability of the conventional two-factor authentication configuration of FIG. 1 is the ability for a malicious user that gains access to password information to easily configure the second authentication factor using any mobile device provided by the malicious user. In conventional scenarios, the website 110 simply has no ability to discern whether the directory number provided by the user is actually owned or otherwise controlled by the user. As such, a conventional authentication service 115 has no choice but to configure the second authentication factor using whatever director number provided by the user. Thus, any malicious user that compromises the password for the first authentication factor can configure the second authentication factor using any mobile device. This allows the security breach by the malicious user to go unnoticed longer, thus allowing the malicious user more time to commit fraudulent online transactions.

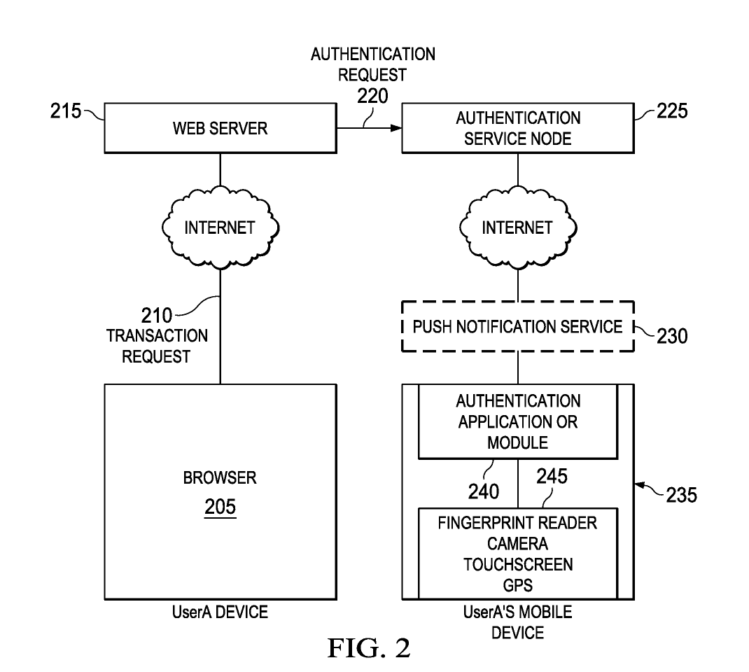

FIG. 2 illustrates an embodiment of the invention for a system providing online transaction authentication. This illustrated embodiment provides authentication of transactions made via a web browser available on a user device 205. The user device 205 may be any computing device capable of allowing the user to operate a web browser or other software application for making online transactions. In the embodiment of FIG. 2, the user device 205 is a device such as a laptop computer or a tablet that provides a conventional web browser by which the user interacts with a web site provided by a web server 215. The user operates the web browser 205 to initiate an online transaction via the web site, for example, choosing to make a purchase from an online merchant. Upon initiating the purchase via the web browser 205, the user device issues a transaction request 210 to the web server 215 of the online merchant.

In order to authenticate the user seeking to make the purchase, the web server 215 uses the information from the transaction request 210 and other information known about the user to generate an authentication request 220, which is dispatched to an authentication service node 225. Unlike the conventional authentication process of FIG. 1, the authentication service node 225 relies on an authentication module or authentication application (AA) 240 on the user's mobile 235. In certain embodiments, the authentication service node 225 may use a push technology service 230 (such as push notifications provide by Apple and Google) to communicate with the authentication application 240 on the user's mobile device 235.

The authentication application or module 240 on the user's mobile device 235 has access to various input functions that are supported by the user's mobile device and configured for operation with the authentication application or module 240. These input functions can be used to request input that can be used to authenticate the user. In the embodiment of FIG. 2, the authentication application or module 240 can utilize input functions that include a fingerprint reader, camera, microphone, touchscreen and GPS. These input functions 245 can be leveraged, according to various embodiments, to confirm that the user is a valid user. Instead of conventional two-factor authentication, such as reading and copying a SMS-delivered code, embodiments of the claimed invention allow authentication that utilizes user information which cannot be easily spoofed by a malicious user. In addition to improving security, certain embodiments can provide authentication while also improving convenience to the user, for example by allowing the user to authenticate web transactions by simply pressing a finger on a fingerprint reader as opposed to having to read and type in a code.

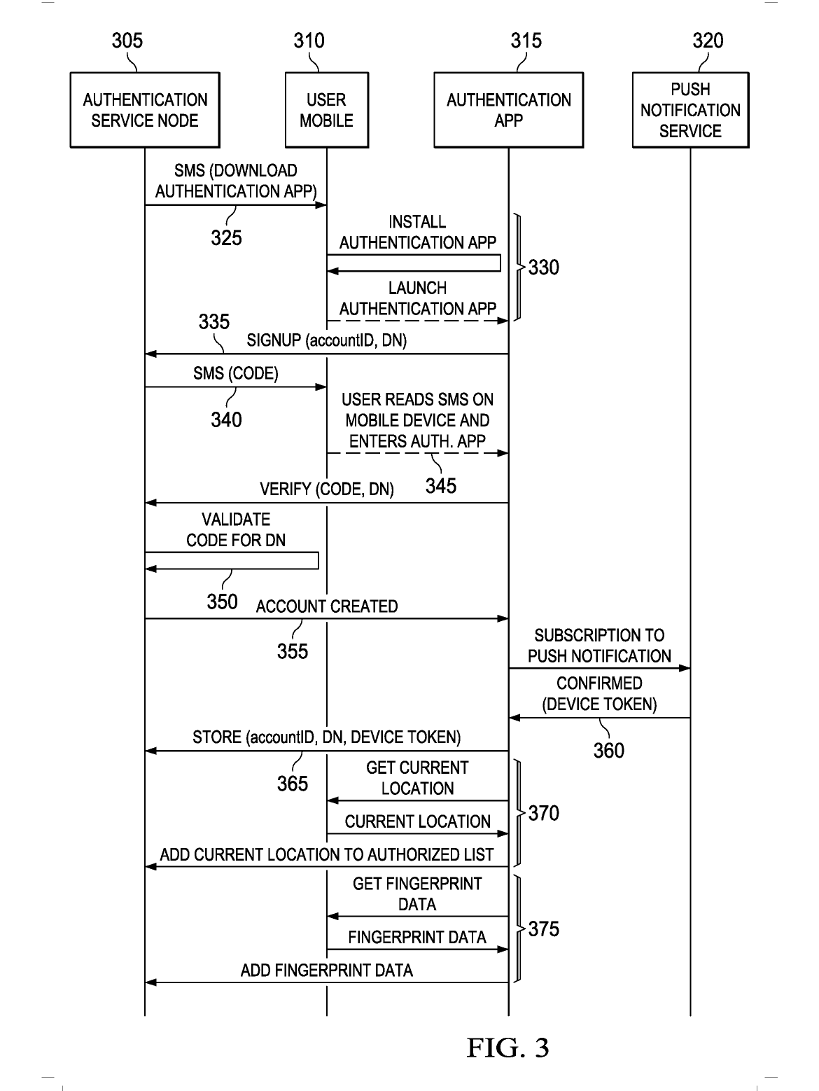

FIG. 3 illustrates certain steps of a process for registering a user's mobile device for use with an authentication service node 305 according to certain embodiments. In the illustrated embodiment, the process begins by the authentication service node 305 sending 325 an SMS message to the mobile device 310 of the user. This might be done for example following a conventional authentication process, to invite users to join the enhanced authentication service.

In certain embodiments, the user will be able to initiate installation of the authentication app 315 at their own discretion, without requiring an SMS invitation from the authentication service node 305. For instance, the user would able to go to the app store, locate the authentication app and install it on their device. In both scenarios, the process continues with the user installing 330 the authentication app 315 on their mobile device 310 and proceeding to launch the authentication app 315.

Once the authentication app 315 has been installed and instantiated on the user's mobile device 310, the app can be used to sign-up the user to the authentication service node 305. This sign-up process begins with the authentication app 315 issuing a sign-up request 335 to the authentication service node 305. In certain embodiments, this sign-up request 335 specifies user information that may include the directory number of the mobile device 310 on which the authentication app 315 has been installed. Certain embodiments may utilize personal information to confirm the identity of the user, such as a user name, address information, date of birth and/or answers to personal identity confirmation questions. Such person information may be provided by the user while creating a user account and can be used during the sign-up process to further confirm the identity of the user.

The authentication service node 305 proceeds by sending 340 an SMS message including a code to the user's mobile device 310. This is done by the authentication service node 305 to ensure that the person initiating the registration requests 335 is actually in control of the user's mobile device 310. The user is prompted to enter 345 the received code into the installed authentication app 315 in order to continue the registration process. The authentication app 315 interacts with the authentication service node 305 to verify 350 whether the code entered by the user matches the code sent via SMS. If the correct code has been provided, the authentication service node confirms 355 successful account creation to the authentication app 315.

To facilitate the communication between the authentication service node 305 and the authentication app 315, in certain embodiments, the authentication app 315 may register with a push notification service 320, such as the push services offered by popular mobile OS vendors Apple and Google. In subscribing 360 to a push notification service 320, the authentication application receives a device token from the push notification service 320 which uniquely identifies the mobile device 310 and the authentication app 315. The authentication app 315 forwards 365 the device token to the authentication service node 305 where it is stored and associated with the user's account and the directory number provided by the user during sign-up 335.

In embodiments that utilize push notifications, subsequent communications between the authentication service node 305 and the authentication app 315 on the user's mobile device 310, the authentication service node 305 sends a message to the push notification service 320, the message including the device token. This message can then be relayed to the user's mobile device 310 by the push notification service 320. When the user opens the received push notification, this activates the authentication application 315 which can use the received notification to continue with authentication process.

In certain embodiments, the configuration of the authentication app 315 continues by requesting the user to provide information that can be used as additional authentication factors that would be difficult to circumvent without a malicious actor providing potentially incriminating information. For instance, in the embodiment of FIG. 3, configuration of the authentication app 315 continues with the authentication app 315 querying the user's mobile device 310 for location information, for instance by querying the GPS coordinates of the mobile device 310 or by location approximation based on cellular and/or WiFi utilization. The location information gathered by the authentication app 315 is then forwarded 370 to the authentication service node 305 where it can be used to deny authentication or authorization of future online transactions, for instance, if the transaction is attempted from unrecognized and/or blacklisted locations, or if the current location of the mobile device does not match or is not in proximity to the user's address.

Similarly, the configuration of the authentication app 315 in the embodiment of FIG. 3 may require the user to provide fingerprint data from their mobile device 310. The authentication app 315 proceeds to forward 375 the fingerprint data to the authentication service node 305. With this fingerprint data on file with the authentication service node 305, it can be used to authenticate or authorize future online transactions. For instance, if an online transaction is initiated at a participating merchant, the authentication service node 305 can issue a push notification to user's mobile device 310, the push notification requiring the user to provide fingerprint authentication of the purchase. The authentication service node 305 can then compare the provided fingerprint versus the fingerprint used to configure the authentication app 315, thus providing an extra measure of security against a malicious user. In other embodiments, the fingerprint can be replaced by voice recognition, facial recognition, iris recognition or any other input that the user can provide to uniquely identify him.

Furthermore, in addition to configuring these additional factors, the installation of the authentication app 315 on the user's mobile device 310 can provide additional opportunities to verifying whether the holder of the mobile device 310 is indeed a legitimate user of the authentication service node 305. For instance, the authentication app 315 may have access to system level and account information on the user's mobile device 310 that can be used to further authenticate the user. Thus, once the authentication app 315 is installed, it can provide additional information to the authentication service node 305 than is provided by the user during registration 335 of the authentication app 315.

In certain embodiments, an online merchant that utilizes the authentication service node 305 can request that a customer provide an account ID. The online merchant can provide this account ID and the directory number being used to the authentication service node 305 to verify that the directory number being used is the same as the directory number that was used to configure the authentication service. This provides the online merchant with the ability to use the configured mobile device authentication scheme, without having to blindly accept any mobile device number provided by the user during the course of the online transaction. This decreases the possibility of malicious acts and has the benefit of freeing the user from having to provide a directory number for each online transaction, since the authentication service node 305 has previously associated 365 the user's authentication service account with the directory number of the mobile device 310 used to configure the authentication app 315. As opposed to the conventional system of FIG. 1, this also prevents a malicious user with a compromised password for an online merchant from bypassing the second authentication factor by simply registering an arbitrary mobile device.

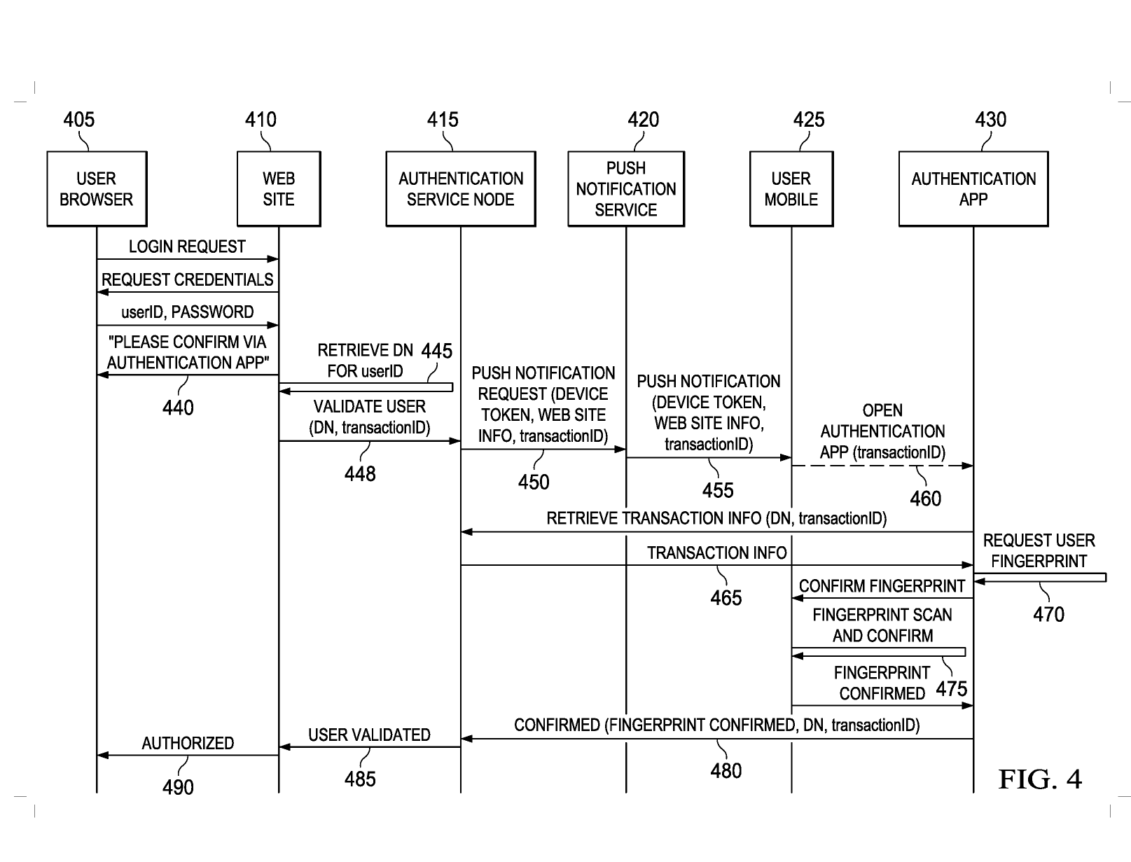

FIG. 4 illustrates the operation of a two-factor authentication scheme according to certain embodiments. In the illustrated embodiment, an authentication app 430 has been previously configured on the user's mobile device 425 and, as part of this configuration, the participating online merchant operating the website 410 has been notified of the directory number of the mobile device 425 used to configure the authentication app 430. As such, a malicious user that has compromised the password for the online merchant cannot authenticate an online transaction without control over the user's mobile device 425.

In the embodiment of FIG. 4, an online transaction begins with the conventional login process 435 whereby the user provides a user id and password information from a web browser 405. The online merchant's website 410 validates the provided user credentials, lithe user successfully completes this first authentication factor, the user is notified 440 via their browser 405 that, in order to complete the purchase, additional authentication will be required via a mobile device 425 that has been previously registered with the authentication service node 415. In this embodiment, the authentication retrieves 445 the directory number that has been associated with the user credentials used to initiate the online transaction on the online merchant's web site 410. In some embodiments, this directory number information is maintained by the authentication service node 415, which responds to the requests from the online merchants for the directory number that is associated with a set of user credentials. In other embodiments, the directory number information is maintained by the online merchant or by a third party.

Using the identification information provided by the user during configuration of authentication app 430, the web site retrieves the directory number provided by the user during configuration and forwards 448 it to the authentication service node 415, along with a unique transaction identifier. In certain embodiments, the authentication service node 415 may begin by validating that the online merchant making the request is authenticated and the web site is valid. The web site validation may be achieved through certificate validation, white list verification or any other suitable means. If the web site is determined to be valid, the authentication service node 415 retrieves the user's account information associated with the provided directory number. This information is used by the authentication service node for the second authentication factor.

Using the directory number associated with the user's authentication service node 415 account and the device token established during configuration of the authentication app 430, the authentication service node issues a request 450 to the push notification service 420 for a push notification. The push notification service 420 proceeds to issue a push notification 455 to the user's mobile device 425 using the device token provided by the authentication service node 415. The receipt of the push notification on the user's mobile device 425 alerts the user, which can open the notification, triggering the authentication app 430 and the authentication or authorization of the online transaction by the user. In the illustrated embodiment, the authentication app 430 queries 465 the authentication service node 415 for additional information regarding the online transaction, using the transaction identifier received with the push notification. In certain embodiments, the additional transaction information that is requested may include the type of transaction, a description or a picture of the item to be purchased, the amount of the purchase, the merchant's identity, a call back number, a location of merchant, and/or the address of pickup or delivery. This additional information can be used further to a greater degree of confidence that the transaction being authenticated or authorized is valid.

Authentication of the online transaction continues in the embodiment of FIG. 4 with the authentication app 430 prompting 470 the user to provide fingerprint authentication or authorization of the transaction. The user provides 475 a fingerprint via the mobile device 425. In this embodiment, the authentication app 430 utilizes mobile device 425 utilities to locally confirm the fingerprint of the user. If the fingerprint is confirmed locally on the mobile device 425, the user does not need to share his fingerprint information with any other party, but can still use fingerprint confirmations to authenticate or authorize the transactions. For more advanced security that may be provided in different embodiments, the fingerprint data can be uploaded to the authentication service node 415 or to an online transaction system, where it could be compared with fingerprint data obtained separately.

Once confirmed, the authentication app 430 then forwards 480 the transaction confirmation to the authentication service node 415 which can log the authentication event and confirm 485 to the online merchant's website 410 that the transaction is confirmed. The user is informed 405 of the successful authentication and allowed to continue the online transaction initiated from the web browser 405.

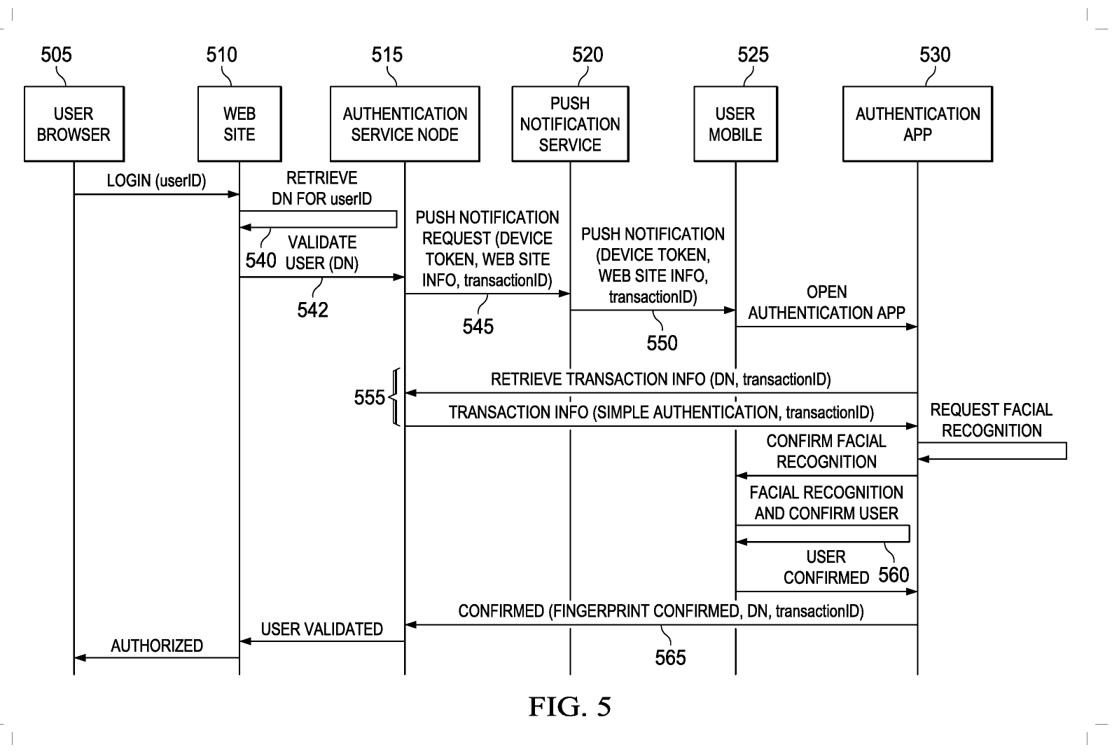

FIG. 5 illustrates the operation of an embodiment that provides online transaction verification using single factor authentication. In this embodiment, rather than relying on the standard password authentication provided by the website 510, the embodiment of FIG. 5 relies on the authentication provided by the authentication service node 515 via an authentication app 530 installed and configured on the user's mobile device 525 in the manner described with respect to FIG. 3. In the embodiment of FIG. 5, the login information provided to the website 510 via the user's web browser 505 is used to retrieve 540 the directory number previously associated with this user by the website 510. That directory number is then used to request 542 authentication of the user via the authentication service node 515 and the authentication app 530. As described, this directory number is established for a particular user during configuration of the authentication app 530 on the mobile device 525 using that directory number.

As with the prior embodiment, the single-factor authentication of FIG. 5 continues with the authentication service node 515 issuing a push notification request 545 to the push notification service 520, which triggers a push notification 550 to the authentication app 530. As before, the authentication app 530 may be used to retrieve 555 additional information regarding the pending transaction from the authentication service node 515. Unlike the embodiment of FIG. 4, however, this embodiment relies on a different user authentication method, in this case, using a facial recognition service 560 provided by the mobile device 525. The facial recognition functions analogously to the previously described fingerprint recognition process in authentication the user. If the facial view provided by the user matches the stored facial profile information, the mobile device 525 confirms the user identity to the authentication application 530. This confirmation is passed to the authentication service node 515 which authenticates or authorizes 565 the transaction based on the confirmed identity of the user. In a different embodiment, the facial recognition could be replaced by an iris scan, or by the user using the mobile touchscreen to draw a user defined shape or pattern with his finger.

By providing a means for single factor authentication other than the web site password validation, an embodiment such as that described with respect to FIG. 5 allows transaction authentication or login authentication without the user having to remember a password. Instead, authentication is performed by the authentication service node 515 using information provided during the configuration of the authentication app 530. Additionally, since the authentication app 530 can be used to provide biometric authentication of the user, the single factor authentication relied upon is more difficult to defeat than the conventional password authentication used by online merchants.

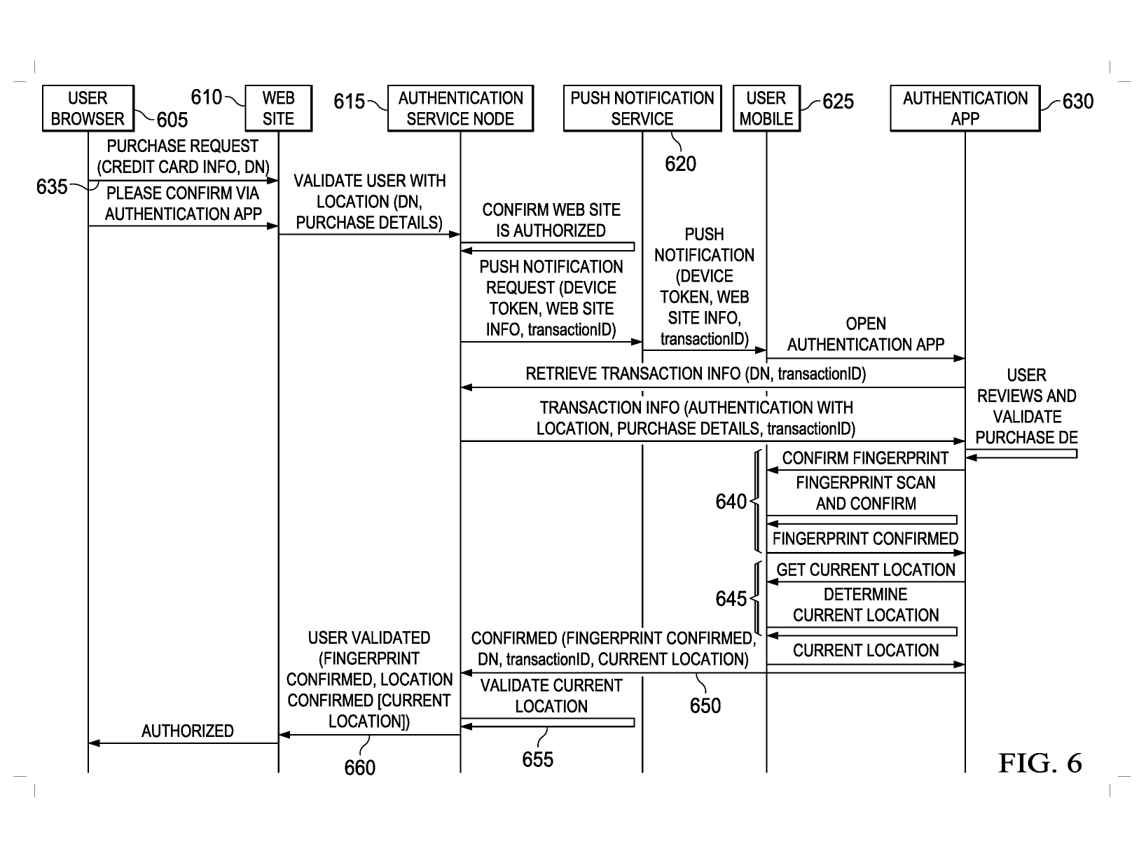

FIG. 6 illustrates the operation of additional embodiment wherein a user initiates an online transaction 635 using a credit card via a web browser 605. To provide additional security, the authentication process is augmented to further authenticate the user based on location information. After the user fingerprints are used to validate the transaction 640, for instance as described with regard to the embodiment of FIG. 5, the authentication app 630 uses the mobile device 625 utilities to capture the user's current location 645. Once the user fingerprints are analyzed and used to confirm the identity of the user in control of the mobile device 625, the location information reported by the mobile device 645 is included 650 by the authentication app 630 when responding to the authentication service node 615.

The authentication service node 615 records the provided location received from the authentication app 630 and uses the location to validate 655 that the transaction is being verified from a valid location. In certain embodiments, the provided location can be validated by comparing it against the user's home and work address, a list of frequently visited locations, a list of previously authorized locations and/or against of list of valid cities, states and/or countries. If the provided location is valid, the authentication service node 615 confirms 660 that the transaction is authenticated and authorized. In certain embodiments, the authentication service node 615 will notify the web site 605 of the online merchant of the provided user location.

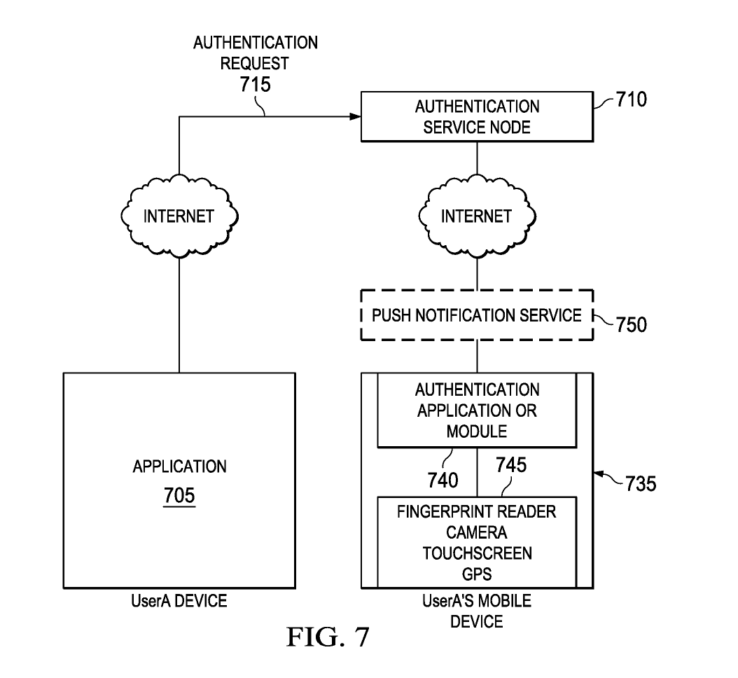

FIG. 7 illustrates a further embodiment where the user′ browser is replaced by a mobile application 705. A mobile application 705 provides services or functions on a smartphone or a tablet, with these service and functions implemented by programs that are integrated with the mobile device operating system instead of being provided from within a web browser. In this embodiment, the mobile application 705 is communicating with the authentication service node 710, directly or via other servers (not shown) to request 715 authentication for a transaction. The two-factor process for user authentication of a transaction proceeds as described above with respect to FIG. 2.

The user operates the mobile application 705 to initiate an online transaction, for example, choosing to make a transaction via a mobile banking application. Upon initiating the transaction via the mobile application 705, a transaction request 715 is issued to the authentication service node 710. In order to authenticate the user seeking to make the transaction, the authentication service node 710 relies on an authentication module or authentication application (AA) 740 on the user's mobile 735. In certain embodiments, the authentication service node 710 may use a push technology service 750 (such as push notifications provide by Apple and Google) to communicate with the authentication application 740 on the user's mobile device 735.

The authentication application or module 740 on the user's mobile device 740 has access to various input functions that are supported by the user's mobile device 735 and configured for operation with the authentication application or module 740. These input functions can be used to request input that can be used to authenticate the user. In the embodiment of FIG. 7, the authentication application or module 740 can utilize input functions 745 that include a fingerprint reader, camera, microphone, touchscreen and GPS. These input functions 745 can be leveraged, according to various embodiments, to confirm that the user is a valid user.

In the embodiments described above, the user identifier that is used to provide the authentication service node is a directory number associated with the user's mobile device. In other embodiments, other types of identification may be used. For instance, certain embodiments may use a SIP (session initiation protocol) URI; an email address or any other type of unique identifier that can be associated with the user's mobile device. In certain embodiments, the user's mobile device may be a tablet, a gaming console, a smartphone, a smartwatch or any other user device capable of interacting with a user. In other embodiment, the authentication application could be replaced with an equivalent authentication function provided natively by the user's mobile device, for example via an OS function. In other embodiments, the user may have multiple devices from which he can perform authentication. For example, the user may have a smartphone and one or multiple tablets. In this scenario, the authentication request may be sent in parallel by the authentication server to all of the user's device with authentication capabilities, allowing the user to perform authentication from any of his devices.

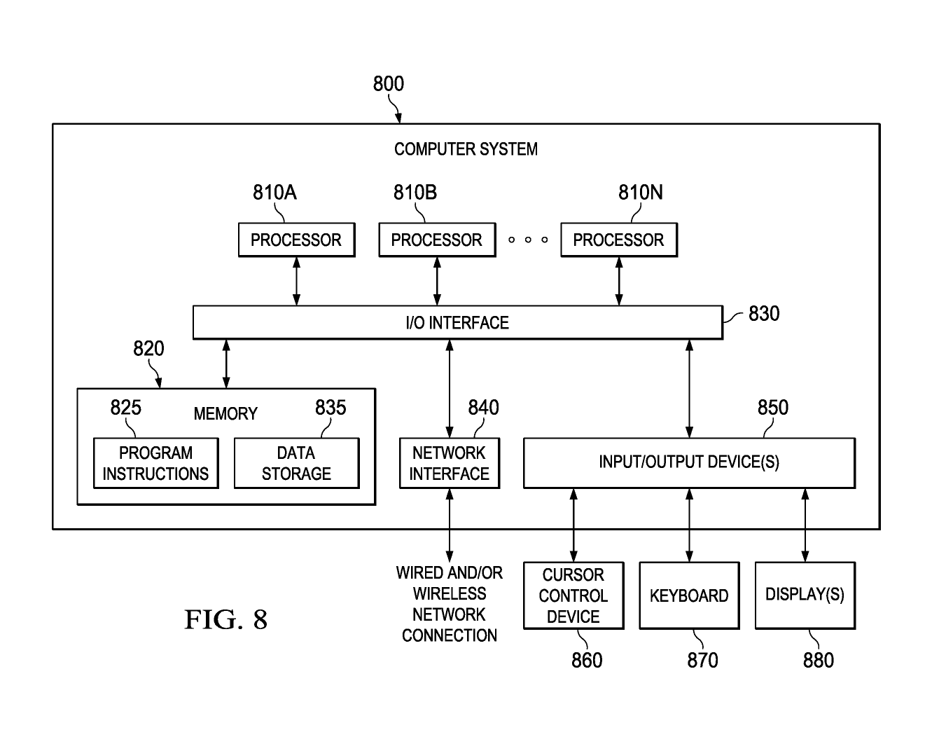

Embodiments of the authentication service node may be implemented using one or more computer systems configure to provide the recited service node. One such computer system is illustrated in FIG. 8. In various embodiments, computer system 800 may be a server, a cloud resource, or any computing device capable of being used to provide an authentication service. In certain embodiments, system 800 may be used to implement the service node described above with regards to FIGS. 1-7. As illustrated, computer system 800 includes one or more processor(s) 810A-N coupled to a system memory 820 via an input/output (I/O) interface 830. Computer system 800 further includes a network interface 840 coupled to I/O interface 830, and one or more input/output devices 850, such as cursor control devices 860, keyboard 870, and display(s) 880.

In various embodiments, computer system 800 may be a single-processor system including one processor 810A, or a multi-processor system including two or more processors 810A-N (e.g., two, four, eight, or another suitable number). Processor(s) 810A-N may include any processor capable of executing program instructions. For example, in various embodiments, processor(s) 810A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processor(s) 810A-N may commonly, but not necessarily, implement the same ISA. Also, in some embodiments, at least one processor 810A may be a network processor.

System memory 820 may be configured to store program instructions (e.g., instructions that implement the service node) and/or data accessible by processor(s) 810A-N. In various embodiments, system memory 820 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in connection with FIGS. 1-7, may be stored within system memory 820 as program instructions 825 and data storage 835, respectively. Additionally or alternatively, the service node may be a software program that is stored within system memory 820 and is executable by processor(s) 810A-N. In other embodiments, program instructions and/or data may be received, sent or stored upon different types of computer-accessible media or on similar media separate from system memory 820 or computer system 800. Generally speaking, a computer-accessible medium may include any tangible or non-transitory storage media or memory media such as electronic, magnetic, or optical media—e.g., disk or CD/DVD-ROM coupled to computer system 800 via I/O interface 830. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, I/O interface 830 may be configured to coordinate I/O traffic between processor(s) 810A-N, system memory 820, and any peripheral devices in the device, including network interface 840 or other peripheral interfaces, such as input/output devices 850. In some embodiments, I/O interface 830 may perform any necessary protocol, timing or other data transformations to convert data signals from one component (e.g., system memory 820) into a format suitable for use by another component (e.g., processor(s) 810A-N). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. In addition, in some embodiments some or all of the functionality of I/O interface 830, such as an interface to system memory 820, may be incorporated directly into processor(s) 810A-N.

Network interface 840 may be configured to allow data to be exchanged between computer system 800 and other devices attached to a network, such as other service nodes. In various embodiments, network interface 840 may support communication via wired or wireless general data networks, such as any suitable type of Ethernet network, for example; via telecommunications/telephony networks such as analog voice networks or digital fiber communications networks; via storage area networks such as FibreChannel SANs, or via any other suitable type of network and/or protocol.

Input/output devices 850 may, in some embodiments, include one or more display terminals, keyboards, keypads, touchpads, scanning devices, RFID readers, NFC readers, voice or optical recognition devices, or any other devices suitable for entering or retrieving data by one or more computer system 800. Multiple input/output devices 850 may be present in computer system 800 or may be distributed on various nodes of computer system 800. In some embodiments, similar input/output devices may be separate from computer system 800 and may interact with one or more nodes of computer system 800 through a wired or wireless connection, such as over network interface 840.

As shown in FIG. 8, memory 820 may include program instructions 825, configured to implement certain embodiments described herein, and data storage 835, comprising various data may be accessible by program instructions 825. In an embodiment, program instructions 825 may include software elements of embodiments illustrated in the above figures. For example, program instructions 825 may be implemented in various embodiments using any desired programming language, scripting language, or combination of programming languages and/or scripting languages (e.g., C, C++, C#, Java™, JavaScript™, Perl, etc.). Data storage 835 may include data that may be used in these embodiments. In other embodiments, other or different software elements and data may be included.

A person of ordinary skill in the art will appreciate that computer system 800 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system or processor-based configurations.

Although certain embodiments are described herein with reference to specific examples, numerous modifications and changes may be made in light of the foregoing description. Accordingly, the specification and figures are to be regarded in an illustrative rather than a restrictive sense, and all such modifications are intended to be included within their scope. Any benefits, advantages, or solutions to problems that are described herein with regard to specific embodiments are not to be construed as a critical, required, or essential feature or element of any or all the claims. Furthermore, it should be understood that the various operations described herein may be implemented in software, hardware, or a combination thereof. The order in which each operation of a given technique is performed may be changed, and the elements of the systems illustrated herein may be added, reordered, combined, omitted, modified, etc. It is intended that the embodiments described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as “connected” and/or “in communication with,” although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method for providing an online transaction authentication service node, the method comprising:
receiving an external request to authenticate an online transaction initiated by a requesting user, wherein the requesting user making the online transaction is identified by a user identifier;
identifying at least one user authentication device associated with the user identifier, wherein the at least one user authentication device is configured to facilitate the authentication of the online transaction by collecting input from the requesting user associated with the user identifier;
sending an authentication request to authenticate the online transaction to the at least one user authentication device;
performing an online transaction authentication determination, wherein the online transaction authentication determination is made based on whether the input provided by the requesting user via the at least one user authentication device matches authentication inputs previously provided by the user associated with the user identifier;
responding to the external request with the online transaction authentication determination.

2. The method of claim 1, wherein the authentication determination is performed on the at least one authentication device using user input stored on the at least one authentication device.

3. The method of claim 1, wherein the authentication determination is performed on the service node using user input provided by the at least one authentication device.

4. The method of claim 1, wherein the input provided by the requesting user includes at least one of: fingerprint input, iris scan input, facial recognition input, touchscreen input, motion sensor input, and voice input.

5. The method of claim 1, wherein the online transaction authentication is for a financial transaction performed via an online service.

6. The method of claim 1, wherein the online transaction authentication is for gaining authenticated access to an online service.

7. The method of claim 1, wherein the online transaction authentication consists of a two factor authentication, where the first factor is a user identifier and a password, and the second factor is provided by the online transaction authentication service node.

8. The method of claim 1, wherein the online transaction authentication consists of a one factor authentication, where the one factor is provided by the online transaction authentication service node.

9. The method of claim 1, wherein the authentication request includes transaction details associated with the online transaction authentication.

10. The method of claim 9, wherein the transaction details includes at least one of: source of the external request, transaction type, transaction amount, transaction currency, merchandise description, merchandise picture, service description, contact information, address information, timestamp, validity time, and location of the transaction.

11. The method of claim 1, wherein the online transaction authentication determination further consists in obtaining the current location of the online transaction authentication device.

12. The method of claim 11, wherein the current location is compared against at least one authorized location for the transaction.

13. The method of claim 11, wherein the current location is provided to the external requester of the online transaction authentication.

14. The method of claim 12, wherein the at least one authorized locations is defined by the requesting user.

15. The method of claim 12, wherein the at least one authorized locations is defined by the external requester of the online transaction authentication.

16. The method of claim 1, wherein the sending by the service node of an authentication request is sent to at least two user authentication devices.

17. The method of claim 1, wherein the at least one user authentication device is one of: smartphone, tablet, smartwatch, computer, gaming console, remote control, door entry system, smart TV, and camera.

18. A system for providing an online transaction authentication service node, the system comprising:
a processor; and
a memory coupled to the processor, the memory storing computer-readable instructions that, upon execution by the processor, cause the system to:
receive an external request to authenticate an online transaction initiated by a requesting user, wherein the requesting user making the online transaction is identified by a user identifier;
identify at least one user authentication device associated with the user identifier, wherein the at least one user authentication device is configured to facilitate the authentication of the online transaction by collecting input from the requesting user associated with the user identifier;
send an authentication request to authenticate the online transaction to the at least one user authentication device;
perform an online transaction authentication determination, wherein the online transaction authentication determination is made based on whether the input provided by the requesting user via the at least one user authentication device matches authentication inputs previously provided by the user associated with the user identifier;
respond to the external request with the online transaction authentication determination.

19. The system of claim 18, wherein the authentication determination is performed on the at least one authentication device using user input stored on the at least one authentication device.

20. The system of claim 18, wherein the authentication determination is performed on the service node using user input stored on the at least one authentication device.
